(19) United States
(12) Patent Application Publication
(10) Pub. No.: US 2005/0279856 A1
(43) Pub. Date: Dec. 22, 2005

(54) Water-conserving surface irrigation systems and methods

(76) Inventors: A. Eugene Nalbandian, Laguna Beach, CA (US); Theodore J. Hunt, Huntington Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/141,170

(22) Filed: May 31, 2005

Related U.S. Application Data
(60) Provisional application No. 60/575,266, filed on May 28, 2004.

(51) Int. Cl. B05B 15/00

(52) U.S. Cl. 239/76; 239/542

(57) ABSTRACT

Preferred aspects of this invention relate to surface irrigation methods, systems and kits for irrigating a ground surface. In particular, these irrigation methods and systems are designed to conserve water and reduce run-off. Embodiments of the irrigation systems comprise a pipe and an emitter assembly, which comprises a sealing adapter, an emitter tube and a pressure compensating flow emitter. In preferred embodiments, such irrigation systems further comprise a controller adapted to transmit and receive data, including weather data, from a remote transceiver and adjust irrigation parameters for the system based on the data.

### RELATED APPLICATIONS

This application claims priority under 35 U.S.C. §119(e) to U.S. Provisional Application No. 60/575,266 filed on May 28, 2004.

### BACKGROUND OF THE INVENTION

1. Field of the Invention

Preferred aspects of this invention relate to surface irrigation methods and systems. In particular, these surface irrigation methods and systems are designed to conserve water and reduce run-off.

1. Description of the Related Art

Traditionally, irrigation methods have included flooding, sprinkling and microirrigation, including drip and microspray. Many of these methods have serious disadvantages, especially with respect to water conservation and delivery. Spray head systems, for example, are only 50-65% efficient. Moreover, such conventional systems commonly cause run-off that poses environmental damage as well as safety problems to passing motorists. Spray head systems also have imperfect wetting patterns and do not effectively take into account the particular characteristics of their environment.

In response to these shortcomings, the wick irrigation concept was developed. Wick irrigation is a method of irrigation applying a fundamental wicking theory to spread water over a semi-permeable medium before entering the soil. In essence, the thatch within grass material acts as a capillary medium to deliver water to a specific region. The capillary action, sometimes referred to as “wicking motion” allows water to rise from a tube located at the plant thatch level and flow outward into the grass thatch and travel along the thatch until it contacts water flowing from another location. At that point, where the flowing water meets, the water stops traveling and infiltrates evenly into the ground.

Wick irrigation has a number of advantages. There is zero overhead spray water loss, greater water efficiency and uniformity, little to no run-off, and a lower pressure requirement. Widespread implementation of wick irrigation has been forestalled, however, by the difficulties posed in creating an inexpensive, easily modifiable, environmentally responsive system. Thus, there remains an important unmet need for an irrigation system configured to facilitate wick irrigation.

### SUMMARY OF THE INVENTION

An irrigation system for irrigating a ground surface is disclosed. The system comprises at least one pipe located beneath the ground surface and coupled to a pressurized fluid source, wherein the at least one pipe further comprises at least one emitter port. The system also comprises at least one emitter assembly coupled to the at least one emitter port and configured to deliver the pressurized fluid from the at least one pipe to the ground surface at a substantially constant flow rate. The at least one emitter assembly comprises: a sealing adapter configured to couple the emitter assembly to the at least one emitter port; an emitter tube having an elongate tubular body sized to convey the pressurized fluid to a location along the ground surface; and a pressure compensating flow emitter configured to permit the pressurized fluid to flow through the emitter assembly to the location at a substantially constant flow rate when the fluid pressure in the at least one pipe is within a permissive pressure range.

In one preferred variation, the permissive pressure range is about 10 to 35 psi.

In another preferred variation, the irrigation system further comprises a valve between the pressurized fluid source and the at least one pipe, and a pressure regulator between the valve and the at least one pipe, wherein the pressure regulator is adapted to maintain the fluid pressure in the at least one pipe within the permissive pressure range when the valve is open.

In another preferred variation, the system further comprising at least one controller adapted to open and close the valve in accordance with a programmed irrigation schedule. The system may also comprise a sensor adapted to monitor a selected irrigation value and communicate the irrigation value to the at least one controller, wherein the controller is further programmed to open or close the valve in response to the irrigation value. The at least one controller may also be configured for two-way communication with a remote transceiver, such that data transmitted from the remote transceiver can modify the programmed irrigation schedule. Preferably, the data transmitted from the remote transceiver relates to weather conditions.

In another preferred variation, the emitter tube further comprises a turbulence regulator that interferes with a flow of pressurized fluid through the emitter tube to the location, thereby creating a backpressure in the emitter tube, such that a controlled emission of pressurized fluid is maintained at the location.

In another preferred variation to the irrigation system, the at least one pipe further comprises a series of pipes interconnected to form a grid beneath the ground surface. The at least one pipe also has a plurality of emitter ports distributed in a predetermined pattern based on an irrigation profile of the ground surface to be irrigated. The plurality of emitter ports may be evenly or unevenly distributed along the at least one pipe. The plurality of emitter ports may be spaced from about 3 inches to about 36 inches from one another.

In another preferred variation, the irrigation system further comprises at least one sealing plug configured to close a selected emitter port or emitter assembly, such that only some of the emitter ports or emitter assemblies are open for irrigating the ground surface.

In another preferred variation, the irrigation system comprises at least one pipe precut in 5, 10 or 20 foot lengths. In another preferred embodiment, the pipe has set-ups (e.g., lengths and emitter assembly spacings) that are factory assembled to scientifically irrigation for the given pre-assessed ground area and environment.

The pressure compensating flow emitter is preferably selected from a variety of different pressure compensating flow emitters each of which is preset to permit a substantially constant flow rate of between 1 and 20 gallons per hour, wherein the selection is based at least in part on a calculated irrigation parameter. The irrigation parameter is preferably determined by a computer program based on input irrigation profile values. One of more of the input irrigation profile variables are selected from the group consisting of soil type, plant type, ground slope, evapotranspiration rate, and weather.

An irrigation system for irrigating a ground surface is disclosed in accordance with another preferred embodiment. The system comprises a series of interconnected PVC pipes arranged to form a grid beneath the ground surface, wherein the PVC pipes are in fluid communication with one another and coupled to a pressurized fluid source comprising a valve and a pressure regulator, and wherein one or more of the PVC pipes has a plurality of emitter ports. The system also comprises a plurality of emitter assemblies configured to deliver the pressurized fluid from the PVC pipes to the ground surface when the valve is open, wherein each emitter assembly comprises: a sealing adapter configured to couple the emitter assembly to an emitter port; an emitter tube having an elongate tubular body sized to convey the pressurized fluid to a location along the ground surface; a pressure compensating flow emitter configured to permit the pressurized fluid to flow through the emitter assembly to the location at a selected flow rate when the fluid pressure is within a permissive pressure range; and a turbulence regulator that interferes with the flow of the pressurized fluid through the emitter tube to the location, thereby creating a backpressure in the emitter tube, such that a controlled emission of pressurized fluid is maintained at the location. This preferred system also comprises a plurality of sealing plugs configured to close selected emitter ports or emitter assemblies, such that only some of the plurality of emitter assemblies are used for irrigating the ground surface. The system also preferably comprises a controller adapted to open and close the valve in accordance with an irrigation schedule, wherein the pressure regulator is adapted to maintain the fluid pressure within the permissive pressure range when the valve is open.

A surface irrigation kit is disclosed in accordance with another preferred embodiment of the present invention. The kit comprises a plurality of PVC pipes, each comprising a plurality of pre-drilled or punched holes; a plurality of sealing adapters, each configured to sealably couple an emitter assembly to a pre-drilled hole; a plurality of emitter tubes, each comprising an elongate tubular body with a turbulence regulator disposed therein; an assortment of different pressure compensating flow emitters, each configured to couple to an emitter assembly and permit a selected constant flow rate there through; and a plurality of sealing plugs, each configured to close a pre-drilled hole or an emitter assembly. The surface irrigation kit also optionally comprises a controller, e.g., a management based controller.

An irrigation method is also disclosed for irrigating a ground surface. The method comprises the steps of: (1) determining a surface irrigation design, comprising emitter assembly spacing based on selected properties of the ground surface; (2) determining surface irrigation parameters, comprising an emitter flow rate and a runtime, based on selected properties of the ground surface; (3) constructing an irrigation system, comprising: a source of pressurized irrigation fluid having a valve; an irrigation pipe in fluid communication with the source of pressurized irrigation fluid, and comprising an emitter port; an emitter assembly coupled to the emitter port via a sealing adapter and comprising an emitter tube with a turbulence regulator and a pressure compensating flow emitter selected to provide the determined emitter flow rate; (4) opening the valve; and (5) closing the valve after the determined runtime.

### BRIEF DESCRIPTION OF THE DRAWINGS

FIG. 1 shows an embodiment of the present invention comprising a pipe and an emitter assembly.

FIGS. 2A-C show exploded schematic views of an emitter assembly, comprising a sealing adaptor, a pressure compensating flow emitter and an emitter tube with a turbulence regulator.

FIGS. 3A-B show schematic views of a sealing adaptor.

FIG. 4 is a schematic view of a surface irrigation system showing a pipe with emitter assemblies in operable connection with a controller.

### DETAILED DESCRIPTION OF THE PREFERRED EMBODIMENT

Wick irrigation is a method of irrigation applying a fundamental wicking theory to spread water over a semi-permeable medium before entering the soil. The method is similar to application of water with a sponge when an appropriate flow rate of water into the sponge is maintained without flowing out of the sponge. In other words, the soaked sponge will contain the water which will make a wetted area the same shape as the shape of the sponge. Wick Irrigation for Grass Field, Joe Hung, DWR Conference, California Polytechnic University Pomona, Feb. 18, 1998.

This method was developed based on the observations of field trial turf tests. However, the water movement in the soil was not observed until numerous laboratory tests were conducted. The theory of wick irrigation as well as computer programs for both wick and wick mixed with sprinkler irrigation were developed in 1996 by Joe Hung.

Although the theoretical aspects and advantages of wick or surface flow irrigation were developed by Dr. Hung several years ago, no systems were ever developed to bring the advantages of surface irrigation out of the laboratory and into the public's hands until Applicants described the various embodiments of the present invention. Indeed, Hung's experimental set-ups utilized two different methods. Both required intensive manual labor to assemble the set-ups in-situ. The set-ups consisted of an eclectic grouping of unrelated parts. The flow emitters used in all of Dr. Hung's set-ups were “vortex” type emitters, which were not pressure compensating. The first and more common installation consisted of only soft tubing. The vortex emitter was attached to a riser that was capped. The riser was a cut away thin walled plastic. Several holes were drilled into the riser and the vortex emitters were attached directly to the riser. A length of flexible 0.220 tubing was run in a small dirt trench that was cut by a hand saw. The soft tubing was pushed into the trench with a screwdriver. At the far end an elbow was inserted into the tube and an additional length of soft tubing brought the opening to the surface.

A second method of system set-up used in Dr. Hung's original experiments was to move the pipe to the emitter location. The pipe was various sizes and stepped down to a ½ inch set-up. The initial pipe was ¾ inches. The length of pipe was cut to a spacing length. Each length was hand measured and hand cut. At this point, a tee was glued to the length of cut pipe. The tee had a threaded joint. The threaded joint and the length of pipe were glued in the 9 to 12 inch deep trench. The thread joint had to be aligned with the previous threaded joint before the glue dried. The glue dried in about 10 seconds. If the threaded joint did not properly align, the new section had to be cut out, a new section prepared and glued into place. The tee had a riser inserted into the threaded joint. The riser was a schedule 80 double-threaded pipe. The pipe had to be hand wrapped with teflon tape to prevent leaking. One end of the riser was hand-inserted into the threaded joint of the tee and tightened with a set of channel locks or vise grips. On the open end of the riser, a threaded plastic cap was screwed onto the riser. Again, channel locks or vise grips to present leaking tightened the cap. The cap had a small hole, into which a vortex emitter was inserted. There was no sealing adapter. A piece of tubing was cut from the roll of soft tubing and attached to the vortex emitter. Additionally, in the first method, the alignment of the outlets was along the contour lines of the slope. Since the vortex emitters were on a series of points with no relationship, the tubing location of individual emitters was untraceable. Second, since the lines were untraceable, replacement of the lines were hampered because a new installation could severe the previous installation. In the second method, the hand assembling caused a few additional problems; e.g., the spacing changed with the slope and was designed to change as the conditions changed. Therefore, there was no true grid but rather a series of patterns and sub-patterns.

In addition to the above-described deficiencies and design pitfalls of the original experimental surface irrigation prototypes, there was no conception or disclosure of an integrated irrigation system, adapted to facilitate the theoretical advantages of surface flow irrigation. More particularly, the experimental setups and publications of Dr. Hung did not disclose or suggest the use of modular components, including use of pressure-compensating flow emitters, pipes with pre-drilled emitter ports, sealing adapters, snap-together emitter assemblies, sealing plugs, turbulence regulators, and system controllers, as employed in various embodiments of the present invention.

Furthermore, preferred embodiments of the present irrigation systems utilize a computer model for obtaining the spacing and flow. This spacing and flow can be compared through the described engineering method. The program allows the user to inspect various parameters to determine if a single grid pattern adapts to acceptable ranges. The grid method surrenders the highest efficiency to reduce the labor of individual patterns and individual set-ups. The system replaces ideal placement of the wick opening with a water management approach through computer programs and where possible the use of a two-way transceiver to monitor and adjust the system. The use of a pre-set unit, a singular grid and management controller improves the number of situations that wick irrigation can practically and economically provide water conservation and reduce runoff.

In Dr. Hung's original experiments, a very uniform wetting pattern was found in a 4 feet by 4 feet test bin with Marathon fescue sod on top of sandy loam soil. The soil was air dried with an average apparent specific gravity of 1.36. The emitter with a flow rate of 24 gallons per hour was set 2 inches horizontally back from the Plexiglas front face.

A uniform wetting depth of 4.5 inches (vertical) was also observed below the sod path of 1.5 feet by 4 feet area after 10 minutes run. 18 hours after the water was turned off, the rectangular wetted pattern remained the same but the wetting front moved another 1.5 inches downward. Several tests with a test bin measuring 8 feet by 8 feet all showed similar results consistently. Several tests were completed to compare the surface wetted areas with an emission point on bare soil and emission point on sod laid over the same, sandy loam soil. With the sod on the soil, the wetted surface area is larger than that without sod. Therefore, the sod was found to help in the wicking or radial distribution of water.

In one embodiment of the present invention, this method can be used for retrofits to irrigate brown spots due to poor water distribution by the sprinkler method or a sole method to irrigate entire turf area.

Several laboratory tests and field irrigation systems installed in Southern California areas have provided proof of principle with regard to wick irrigation as embodied in preferred aspects of the present invention.

Applications of the wick irrigation method may have the following potential advantages:
1. increased irrigation efficiencies and water savings compared with conventional methods of irrigation
2. low fluid pressure required—similar to the pressure required for microirrigation
3. high distribution uniformity (higher than sprinkler irrigation)
4. relatively larger surface wetted area for level soil areas, resulting in a greater spacing of emitters between points than for conventional subsurface drip irrigation methods
5. high flow rates allow delivery at the application point using other emission configurations besides the preferred emitter assemblies; e.g., a bubbler can be used
6. this method is not affected by wind
7. this method may also be applied to irrigate a tree or shrub by spreading wicking material around its stem with a single emitter or bubbler rather than a number of emitters
8. less problems of root intrusion and clogging into the emitter assembly since the emission orifice is larger in preferred embodiments compared to conventional drip irrigation tubes
   Optimization of System Parameters: Emitter Flow Rate and Spacing

Laboratory test results suggested that wick irrigation has great potential in turf grass irrigation applications. Of course other irrigation applications besides grasses are also encompassed by embodiments of the present invention, including agricultural (crops) and ornamental applications. Because of its high flow rate application, the clogging of emitter assemblies is generally minimized.

Assuming that the soil moisture infiltration pattern is cylindrical and the plant root density is high, spacing of emitter assemblies depends mainly on the following factors:
1. Soil texture and structure
2. Total amount of water applied per irrigation application
3. Hydraulic conductivity of the soil
4. Rooting depth
5. Land slope
6. Emitter flow rate (runtime depends on spacing)

The maximum emitter spacing is governed by the type of soil including both texture and structure, the volume of water applied per irrigation application, the hydraulic conductivity of the soil, the emitter flow rate, the plant rooting depth or the desired watering depth, etc. Schartzmass and Zur⁽⁵⁾ applied various amounts of water using point water sources and developed two empirical formulas describing the maximum vertical and horizontal movement of water wetting fronts in soil. Their formulas are listed below.
z=K₁R^{0.63}(Kₛ/q)^{0.45} (1)
where z=vertical distance to wetting front (ft or m)

K₁=empirical constant, 71.3 for English unit and 29.2 for metric unit.

R=volume of water applied (gallons or liters)

Kₛ=saturated hydraulic conductivity (ft/sec or m/sec)

q=emitter flow rate (gallons/hour or liters/hour)
s=K₂R^{0.22}(Kₛ/q)^{-0.17} (2)
where s=wetted width or diameter of wetting pattern (ft or m)

K₂=empirical constant, 0.206 for English unit and 0.031 for metric unit

R=volume of water applied (gallons or liters)

Kₛ=saturated hydraulic conductivity (ft/sec or m/sec)

q=emitter flow rate (gallons/hour or liters/hour)

Combining equations (1) and (2) and solving for q, we have
q=1.25×10⁴R^{0.661}Kₛ(s/z)^{1.61} (3)

Hung⁽⁶⁾ suggested the following equation for maximum irrigation runtime.
t=0.0748C(FC−PWP)Aₛz s²/q E (4)
where t=irrigation runtime (hrs)

C=the fraction of the available soil moisture depletion in decimal

FC=field capacity (% be oven-dry weight)

PWP=permanent wilting point (% by oven-dry weight)

Aₛ=apparent specific gravity

z=rooting depth or water depth (ft or m)

s=emitter spacing (100% wet; ft or m)

q=emitter flow rate (gallons/hour or liters/hour)

E=irrigation efficiency.

Combining equations (3) and (4), we have
t=R/q Eₐ (5)
where R=0.0748 C (FC−PWP) Aₛ z s²=total volume of water applied

q=emitter flow rate obtained from equation (3)

E=irrigation efficiency

Incorporating equations (4) and (5) with the maximum irrigation without runoff (see equation (6) below) developed by Hung and Krinik⁽⁷⁾, it is possible to determine the following through a simple computer program.
The vertical distance of the wetting front
The horizontal distance of the wetting front
The emitter spacing
The final percent of the available soil moisture depletion
The total volume of water applied
The required emitter flow rate
Required number of emitters
The irrigation runtime
The irrigation interval

To prevent the runoff, it is preferred that an infiltration test be performed. The data are plotted against the elapsed time. Then based on the maximum run time developed by Hung and Krinik⁽⁷⁾, calculate the maximum runtime per irrigation application.
tₘₐₓ=(1/pb){f₀−p+f_{c}ln[(fₒ−f_{c})/(p−f_{c})]} (6)
where tₘₐₓ=maximum runtime (hr)*

p=precipitation rate (in/hr)

b=a constant is obtained from Horton's equation by infiltration data

fₒ=initial soil infiltration capacity (in/hr)

f_{c}=minimum soil infiltration capacity, almost at saturation (in/hr)

* tₘₐₓ is reduced by land slope as detailed by Hung, Joe Y. T. (1996) Landscape Sprinkler Irrigation (Principles, Design and Management). By ASK Printing, Pomona, Calif.

The constants fₒ, f_{c}, b can be obtained from Horton's equation which is,
f=f_{c}+(fₒ−f_{c})e^{-bt} (7)
where f=soil infiltration capacity at time “t” in hrs.

Equations (3), (4) and (5) make it possible to construct Table 1^{(5,6,7)} to show the relationship among the emitter flow rate, spacing and various types of soils for level lawn area.

TABLE 1
Relationship among soil texture, emitter flow rate*\, emitter spacing and
precipitation rate for level land

| | | Flow Rate (gallons | Precipitation Rate |
|---|---|---|---|
| Type of Soil | Area (ft²) | per hour) | (in/hr) |
| Sandy Soil | 1 | 0.5 | 0.80 |
| | 4 | 3.9 | 1.56 |
| | 9 | 12.8 | 2.28 |
| Sandy Loam Soil | 4 | 2.5 | 1.00 |
| | 9 | 8.2 | 1.46 |
| | 16 | 19.1 | 1.92 |
| Loam Soil | 4 | 1.6 | 0.64 |
| | 9 | 5.1 | 0.91 |
| | 16 | 11.9 | 1.19 |
| Clay Loam Soil | 4 | 1.0 | 0.40 |
| | 9 | 3.3 | 0.59 |
| | 16 | 7.7 | 0.77 |
| | 25 | 14.9 | 0.96 |
| Clay | 4 | 0.8 | 0.32 |
| | 9 | 2.5 | 0.45 |
| | 16 | 5.8 | 0.58 |
| | 25 | 11.1 | 0.71 |

*If the calculated irrigation interval is changed, the emitter flow rate and precipitation rate will also be slightly changed.
\If the total flow rate exceeds the highest single emitter flow rate, a multiple outlet emitter may be used.

Table 1 was established based on the following assumptions:
1. The ground surface is level
2. The soil physical properties are representative average. The actual value may be found through experimental procedures
3. The irrigation efficiency (or uniformity coefficient, etc.)=85%. Wick irrigation could actually have an efficiency much higher than this
4. Available soil moisture depletion=50%
5. The rooting depth of grass=6 inches
6. Without considering evapotranspiration rate and irrigation interval adjustment

Table 1 may be used to calculate irrigation runtime when evapotranspiration rate is known. Apply Table 1 to find the proper emitter flow rate, required daily irrigation runtime if an area of 4 feet by 4 feet to be watered. For example, for sandy loam soil and an evapotranspiration rate of 0.2 inches per day, the required emitter flow rate is 19.1 gallons per hour and the required daily irrigation runtime is 0.2/1.92=0.104 hrs or 6.25 minutes.

The wick irrigation method provides higher irrigation efficiency because the water distribution uniformity is extremely high. Laboratory test results have confirmed the theoretical results.

The emitter flow rates shown in Table 1 with spacing the irrigation runtime and irrigation interval consider the properties of soil, climatic conditions, and land slope. The marathon sod used for the experiments did well in doing wicking or thatching. The time lag between the beginning of water application and the starting of infiltrating into soil are so small that it may be ignored in practical applications.

A computer program was developed to provide automated calculation of the design and irrigation parameters (e.g., flow rate, irrigation runtimes, shown manually above) based on the irrigation profile (e.g., soil property, climate, and slope, etc.) of the ground surface.

The program utilizes the basic soil properties, plant materials and fundamentals of surface flow irrigation to generate an irrigation system design (distribution of emitter assemblies) and irrigation parameters (flow rates and runtimes) to meet the irrigation demands of the particular area. The irrigation parameters generated by the program will vary from project to project depending on inter alia the plants (agricultural crops, ornamental plantings, or turfgrasses), the soil, the slope, the climate, as well as acute changes in the weather. Instead of individual calculations, the software uses relational values. For example, in preferred embodiments, the designer may be prompted to enter the following data:
Soil type (e.g., sandy, sandy loam, loam, clay loam, and clay)
Plant type (e.g., turf type)

The designer is also prompted to enter irrigation profile values, known to those of skill in the art. Typical irrigation profile values for different geographical areas are preferably provided to the irrigation designer along with the software (see e.g., Table 2, showing historical ET data for southern California). In preferred embodiments, the program prompts for irrigation profile values including:
Daily evapotranspiration rate (“ET”)
System efficiency
Allowable moisture depletion

The designer is preferably then prompted to enter site information or a starting point for the design. This may include:
Initial spacing of emitter assemblies
Type of spacing (e.g., square, triangular, circular, etc.)
Root depth
Slope of the ground surface (e.g., mild (0-5% incline), slight (6-8%), medium (9-12%), sharp (13-20%), steep (>21%), etc.)

Although final emitter assembly spacing is preferably determined by the computer calculations, initial spacing input is preferably provided by the designer as a starting point.

TABLE 2
Los Angeles County

| | JAN | FEB | MAR | APR | MAY | JUN | JUL | AUG | SEP | OCT | NOV | DEC |
|---|---|---|---|---|---|---|---|---|---|---|---|---|
| Burbank | 2.1 | 2.8 | 3.7 | 4.7 | 5.1 | 6.0 | 6.6 | 6.7 | 5.4 | 4.0 | 2.5 | 1.9 |
| Glendora | 1.9 | 2.5 | 3.6 | 4.9 | 5.4 | 6.1 | 7.3 | 6.8 | 5.7 | 4.1 | 2.6 | 1.9 |
| Gorman | 1.6 | 2.1 | 3.4 | 4.6 | 5.5 | 7.4 | 7.7 | 7.1 | 5.9 | 3.6 | 2.4 | 1.1 |
| Lancaster | 2.1 | 3.0 | 4.6 | 5.9 | 8.5 | 9.7 | 11.0 | 9.8 | 7.3 | 4.6 | 2.8 | 1.7 |
| Long Beach | 2.2 | 2.5 | 3.4 | 3.8 | 4.8 | 5.0 | 5.3 | 4.9 | 4.5 | 3.4 | 2.4 | 1.9 |
| Los Angeles | 2.2 | 2.6 | 3.7 | 4.7 | 5.5 | 5.8 | 6.2 | 5.9 | 5.0 | 3.9 | 2.6 | 1.9 |
| Palmdale | 1.9 | 2.6 | 4.1 | 5.1 | 7.6 | 8.5 | 9.9 | 9.8 | 6.7 | 4.1 | 2.6 | 1.7 |
| Pasadena | 2.1 | 2.6 | 3.7 | 4.7 | 5.1 | 6.0 | 7.1 | 6.7 | 5.6 | 4.1 | 2.6 | 1.9 |
| Pearlblossom | 1.7 | 2.4 | 3.7 | 4.7 | 7.3 | 7.7 | 9.9 | 7.9 | 6.4 | 4.0 | 2.6 | 1.6 |
| Redondo Beach | 2.2 | 2.4 | 3.3 | 3.8 | 4.5 | 4.7 | 5.4 | 4.8 | 4.4 | 2.8 | 2.4 | 1.9 |
| San Fernando | 1.9 | 2.6 | 3.5 | 4.6 | 5.5 | 5.9 | 7.3 | 6.7 | 5.3 | 3.9 | 2.6 | 1.9 |

Orange County

| | JAN | FEB | MAR | APR | MAY | JUN | JUL | AUG | SEP | OCT | NOV | DEC |
|---|---|---|---|---|---|---|---|---|---|---|---|---|
| Laguna Beach | 2.2 | 2.6 | 3.4 | 3.8 | 4.6 | 4.6 | 4.9 | 4.9 | 4.4 | 3.4 | 2.4 | 1.9 |
| Santa Ana | 2.2 | 2.6 | 3.7 | 4.5 | 4.6 | 5.4 | 6.2 | 6.1 | 4.7 | 3.7 | 2.5 | 1.9 |

Riverside County

| | JAN | FEB | MAR | APR | MAY | JUN | JUL | AUG | SEP | OCT | NOV | DEC |
|---|---|---|---|---|---|---|---|---|---|---|---|---|
| Beaumont | 1.9 | 2.3 | 3.4 | 4.4 | 6.1 | 7.1 | 7.6 | 7.9 | 6.0 | 3.9 | 2.6 | 1.7 |
| Blythe | 3.2 | 4.2 | 6.7 | 8.9 | 11.1 | 12.4 | 12.8 | 11.1 | 9.1 | 6.7 | 4.0 | 2.7 |
| Coachella | 2.9 | 4.4 | 6.2 | 8.4 | 10.5 | 11.9 | 12.3 | 10.1 | 8.9 | 6.2 | 3.8 | 2.4 |
| Desert Center | 2.9 | 4.1 | 6.4 | 8.5 | 11.0 | 12.1 | 12.2 | 11.1 | 9.0 | 6.4 | 3.9 | 2.6 |
| Elsinore | 2.1 | 2.8 | 3.9 | 4.4 | 5.9 | 7.1 | 7.6 | 7.0 | 5.8 | 3.9 | 2.6 | 1.9 |
| Indio | 2.9 | 4.0 | 6.2 | 8.3 | 10.5 | 11.9 | 12.3 | 10.0 | 8.9 | 6.4 | 3.8 | 2.4 |
| Palm Desert | 1.9 | 3.5 | 4.9 | 7.7 | 8.5 | 10.6 | 9.8 | 9.1 | 8.4 | 6.1 | 2.7 | 1.8 |
| Palm Springs | 1.9 | 2.9 | 4.9 | 7.2 | 8.3 | 8.5 | 11.6 | 8.3 | 7.2 | 5.9 | 2.7 | 1.7 |
| Riverside | 2.1 | 2.9 | 4.0 | 4.1 | 6.1 | 7.1 | 7.9 | 7.6 | 6.1 | 4.1 | 2.6 | 1.9 |

San Bernardino County

| | JAN | FEB | MAR | APR | MAY | JUN | JUL | AUG | SEP | OCT | NOV | DEC |
|---|---|---|---|---|---|---|---|---|---|---|---|---|
| Baker | 2.7 | 3.9 | 6.1 | 8.3 | 10.4 | 11.8 | 12.2 | 11.0 | 8.9 | 6.1 | 3.3 | 2.1 |
| Barstow | 2.6 | 3.6 | 5.7 | 7.9 | 10.1 | 11.6 | 12.0 | 10.4 | 8.6 | 5.7 | 3.3 | 2.1 |
| Chino | 2.1 | 2.9 | 3.9 | 4.5 | 5.7 | 6.5 | 7.3 | 7.1 | 5.9 | 4.1 | 2.6 | 1.9 |
| Crestline | 1.5 | 1.9 | 3.3 | 4.4 | 5.5 | 6.6 | 7.8 | 7.1 | 5.4 | 3.5 | 2.2 | 1.6 |
| Lucerne Valley | 2.2 | 2.9 | 5.1 | 6.5 | 9.1 | 11.0 | 11.4 | 9.9 | 7.4 | 5.0 | 2.9 | 1.8 |
| Needles | 3.2 | 4.2 | 6.6 | 8.9 | 11.0 | 12.4 | 12.8 | 11.0 | 8.9 | 6.6 | 4.0 | 2.7 |
| San Bernardino | 1.9 | 2.6 | 3.8 | 4.6 | 5.7 | 6.9 | 7.9 | 7.4 | 5.9 | 4.1 | 2.6 | 1.9 |
| Twentynine Palms | 2.6 | 3.6 | 5.9 | 7.9 | 10.1 | 11.2 | 11.2 | 10.2 | 8.6 | 5.9 | 3.4 | 2.2 |
| Victorville | 2.3 | 3.1 | 4.9 | 6.7 | 9.3 | 10.0 | 11.2 | 9.8 | 7.4 | 5.1 | 2.8 | 1.8 |

San Diego County

| | JAN | FEB | MAR | APR | MAY | JUN | JUL | AUG | SEP | OCT | NOV | DEC |
|---|---|---|---|---|---|---|---|---|---|---|---|---|
| Chula Vista | 2.2 | 2.6 | 3.4 | 3.8 | 4.9 | 4.7 | 5.5 | 4.9 | 4.5 | 3.4 | 2.4 | 1.9 |
| Escondido | 2.1 | 2.8 | 3.8 | 4.7 | 5.6 | 6.7 | 6.8 | 6.5 | 5.4 | 3.8 | 2.5 | 1.9 |
| Oceanside | 2.2 | 2.6 | 3.4 | 3.7 | 4.9 | 4.6 | 4.6 | 5.1 | 4.1 | 3.3 | 2.4 | 1.9 |
| Pine Valley | 1.5 | 2.4 | 3.8 | 5.1 | 6.0 | 7.0 | 7.8 | 7.3 | 6.0 | 4.0 | 2.2 | 1.7 |
| Ramona | 2.1 | 2.5 | 4.0 | 4.7 | 5.6 | 6.5 | 7.3 | 7.0 | 5.6 | 3.9 | 2.5 | 1.7 |
| San Diego | 2.2 | 2.5 | 3.3 | 3.4 | 4.4 | 4.0 | 4.6 | 4.6 | 3.9 | 3.3 | 2.2 | 1.9 |
| Santee | 2.1 | 2.6 | 3.7 | 4.5 | 5.5 | 6.1 | 6.6 | 6.2 | 5.4 | 3.8 | 2.6 | 1.9 |
| Waner Springs | 1.6 | 2.6 | 3.7 | 4.7 | 5.7 | 7.6 | 8.3 | 7.7 | 6.3 | 4.0 | 2.5 | 1.3 |

Based on the above irrigation profile input, the program preferably provides results that included estimated:
Initial intake rate (soil uptake of water at the start)
Precipitation rate (water dispersed by the irrigation system per unit area per unit time)
Basic intake rate (soil uptake of water after saturated)
Row spacing
Emitter assembly spacing
Flow rate
Maximum run time before runoff
Total suggested run time for optimal surface irrigation

The designer next reviews the results and adjusts the factors above. This is the common engineering approach. The engineering approach is to establish the top priority factors, and then adjust the design factors to complete the final design. By using a spreadsheet and relational calculations, the designer can select spacing and changeable factors. Second, moisture depletion and root depth can be adjusted to determine if the parameters are within acceptable range. This will allow landscape architects and irrigation engineers to determine if conditions have changed enough as to require new pressure compensating flow emitters in the emitter assemblies or new row spacing.

After trying several different factors and reviewing the range of parameters, the designer preferably makes a final decision as to the row and emitter assembly spacing. The emitter assembly spacing is to the nearest 0.1, 0.5 or 1 foot, preferably to the nearest 0.5 foot. The row spacing can vary. The flow rate is also selected based on a whole number and can vary from between about 1 and 20 gallons per hour.

The next step is to determine if a top row and a bottom row is required. In preferred embodiments, the software automatically transfers values and calculations to a different spreadsheet. The spacing and flow rate that the designer selected are transferred. The designer enters a flow rate and a new spacing. The distant to the top is assumed to be zero for the top row. The designer preferably attempts to establish a top row precipitation rate near the initial intake rate. The top should not be along the edge but offset by a few inches. When the distance to the top of the slope is entered, the precipitation rate is preferably slightly below the initial intake rate. This will preferably prevent brown spots and is the furthest point from the bottom. As the far point, runoff is minimized.

Next, the designer attempts to establish a bottom row precipitation rate near the basic intake rate (as opposed to the initial intake rate—as used for top row design). This spacing is designed to prevent runoff in sensitive areas. The principle is the reverse of the top. The spacing and the flow are entered first and then the distance from the edge is determined. Since the surface flow from an emitter assembly is typically circular, the area is increasing by a squared value. The precipitation is decreasing by a similar inverse of the square. This means that a few inches can prevent most, if not all, of the runoff.

Finally, after the designer has prioritized and optimized irrigation parameters and established top and bottom row spacing and flow rates so as to minimize runoff, the program generates estimates for the amount of piping and number of emitter assemblies suggested for providing the optimized surface flow irrigation grid.

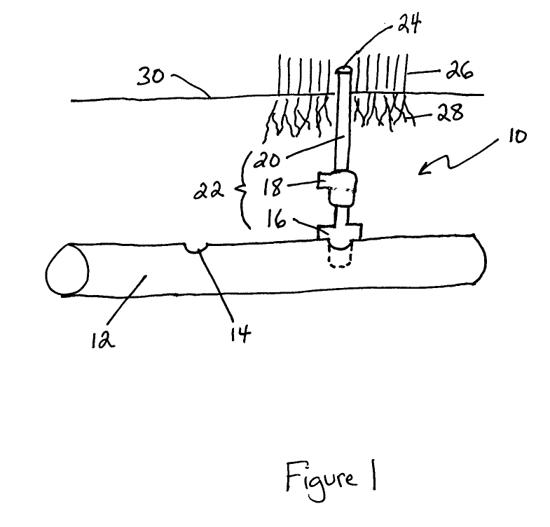

In one embodiment of the present invention, an irrigation system is provided, which provides substantial water conservation benefits and minimizes runoff. Referring to FIG. 1, this system 10 may comprise a section of pipe 12 with one or more holes or emitter ports 14. The pipe 12 is fluidly coupled to a source of pressurized irrigation fluid. Preferably, the source has a valve and a pressure regulator, which is adapted to maintain the pressure in the system between about 10 and 35 psi when the valve is open, and more preferably between about 20 and 30 psi. Optionally, the pressurized fluid source also comprises a filter.

An emitter assembly 22 is sealably coupled to an emitter port, and extends from the pipe to a location along the ground surface 30; the coupling may be reversible or permanent. The illustrated emitter assembly 22 comprises a sealing adapter 16 coupled to an emitter tube 20, and disposed along the length of the emitter, is a pressure compensating flow emitter 18, which provides a constant flow rate through the emitter assembly 22 as long as the pressure within the pipe 12 is maintained in the permissive range (e.g., about 10-35 psi, more preferably about 20-30 psi). The flow emitter 18 is selected from a variety of different available emitters having preset flow rates within the permissive pressure range. For example, pressure compensating flow emitters can be selected so as to provide a desired constant flow rate within the range of about 1 to about 20 gallons per hour. Emitters can be selected in approximately 1 gallon per hour increments from 1-20 gallons per hour. Typical commercially available emitters have 1, 2, 5, 7 and 12 gallon per hour preset flow rates. In a variation to this embodiment, the flow emitter 18 may have an adjustable pressure threshold, which can be set to a particular desired flow rate during installation. Alternatively, a flow emitter 18 may be automatically adjusted by a controller, through direct electrical communication (hard wiring) or through radio signal. The automatically adjustable emitter would further comprise an actuating means for making the adjustment, e.g., solenoid-actuated valve.

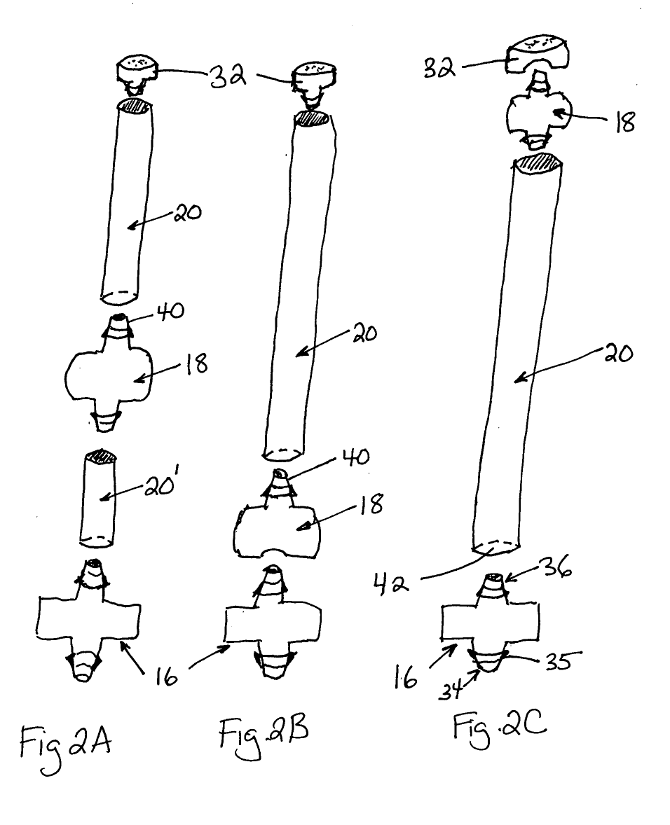

The pressure compensating flow emitter 18 may be placed anywhere along the length of the emitter assembly, including interposed between the emitter tube 20 and the sealing adapter 16 as shown in FIG. 1 and FIG. 2B, in the middle of the emitter tube (which can be cut and spliced) as shown in FIG. 2A, or at or near the distal end region of the emitter tube as shown in FIG. 2C. The emitter assembly preferable extends just above the ground surface 30, within the turf 26, so the opening of the emitter assembly 24 releases irrigation fluid into the turf 26, whereby it can spread along the ground surface 30 through the wicking (capillary) action created by the turf thatch, and then permeate downward into the soil where the roots 28 reside.

The pipe 12 may be conventional PVC piping, as is well known to those of skill in the art. By having hard piping, many underground complications are obviated, such as clogging, insect intrusion, animal damage, etc. However, other pipes may also be used, including any conduit along which a fluid might flow. In a preferred embodiment, the PVC pipe is drilled with holes, or “emitter ports” 14 that are spaced evenly apart based upon the needs of the wick irrigation spacing formula, although uneven hole spacings may be preferred in certain applications.

As discussed above, and shown in greater detail in FIGS. 2A-C, the emitter assembly 22 preferably comprises a sealing adapter 16 which facilitates reversible or permanent coupling of an emitter assembly 22 to an emitter port 14 in the pipe 12. In some embodiments, the sealing adapter may comprise a tapered, conical or straight cylindrical coupling member, nozzle, or “barb” 34 having one or more structures 35 adapted to lock-and-seal into place once pressed into the emitter port of the pipe 12. The adapter may also comprise an upper nozzle 36. The lower nozzle 34 is for coupling with the emitter port 14 in a pipe 12, whereas the upper nozzle 36 is for coupling with the emitter assembly (e.g., the emitter tube 20 or the pressure compensating flow emitter 18). FIGS. 2A-C illustrate some of the possible variations for assembling the emitter assemblies. In FIG. 2A, the sealing adapter 16 is shown coupling upward to a portion the emitter tube 20, which then couples to the pressure compensating flow emitter 18, which then couples to another length of the emitter tube 20, within or upon which is optionally coupled a turbulence regulator 32. The turbulence regulator may be a screen, like those commonly used on the ends of kitchen spigots, or it may be a porous structure that is lodged within the emitter tube anywhere between the pressure compensating flow emitter 18 and the distal opening 24 of the emitter tube 20. The turbulence regulator creates a back-pressure on the flow emitter and interferes with the outflow of irrigation fluid, such that an even flow onto the ground surface is created—which avoids spurting or other turbulence issues that might compromise an even surface flow and ground coverage.

The lock-and-seal structures 35 may be any structures known in the art for creating a locked and sealed connection. For example, the lock-and-seal structures 35 may include a sprung or barbed annular member that locks into place within a complementary structure(s) within the emitter port, thereby insuring a more permanent sealed connection between the emitter assembly and the pipe. In other embodiments, the coupling nozzle 34 may be tapered with one or more flexible elastomeric annular members or rings (or other flexible structures), that create a sealed connection between the adapter and the emitter port, but allow the connection to be reversed by pulling the coupling nozzle out of the emitter port. In other variations, the inside wall of the emitter port may be modified to include sealing rings that reversibly couple and seal the coupling nozzle of the sealing adapter within the emitter port. In other embodiments, both the coupling nozzle and the emitter port may be threaded, so the sealing adapter can be reversibly screwed into the emitter port, wherein the threads are configured to create a sealed connection, e.g., using elastomeric materials, minimal tolerance threading, Teflon coating, etc.

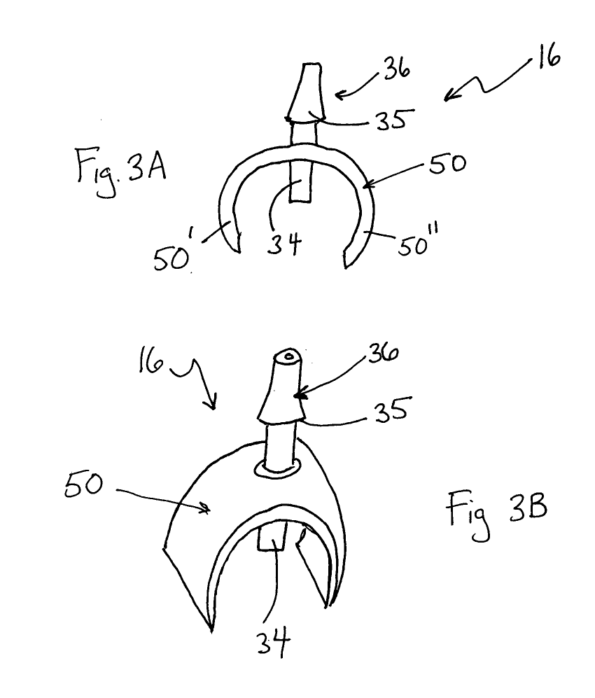

In another embodiment, the sealing adapter 16 may have a sprung annular sleeve 50 that wraps around a portion of the pipe 12, as illustrated in FIGS. 3A-B. This embodiment of the sealing adapter 16 may also have similar coupling nozzles 34 and 36, with or without one or more sealing structures 35. The sealing adapter 16 allows fluid communication between the interior of the pipe 12 and the interior of the emitter assembly. The annular sleeve 50 is shown comprising more than one half of the circumference of the pipe, wherein it may be pushed onto a pipe with sufficient force to cause the wings 50′ and 50″ to separate and then snap back into position wrapped around the pipe. In preferred embodiments, the annular sleeve is formed from a material, such as a plastic or metal, which permits plastic deformation during installation, and allows the wings to return to their original conformation. The lower nozzle 34 is shown as a conical tube without sealing structures, configured to fit within an emitter port within a pipe. The top nozzle 36 is illustrated as comprising a barb 35 adapted to sealably couple with the adjacent component of the emitter assembly (e.g., a section of emitter tube 20 or pressure compensating flow emitter). The sealing adapter 16 seals the system, such that leakage of pressurized irrigation fluid at the coupling site is eliminated or minimized. Regardless of the configuration of the sealing adapter 16, its coupling nozzle(s) 34, 36 are preferably fashioned at least in part from plastic, rubber or other elastomeric material adapted to provide the desired seal and the reliable coupling. The sealing adapter is preferably adapted to create a liquid-tight seal with the PVC pipe. Of course, in other embodiments, other means of creating a seal may be used, such as a wide variety of seals, gaskets, fittings and sealants well known to those of skill in the art.

As can be appreciated from the above description, the preferred irrigation system can be supplied as modular components, for example in a kit, that can be readily configured and snapped together as suggested by the design and irrigation parameters (e.g., emitter assembly spacing, flow rates, irrigation runtimes, etc.) based on the irrigation profile of the ground surface (soil, plants, and climate, etc.). Thus, using the equations described above, preferably as implemented through Applicants' computer program, a designer or other user may determine the irrigation parameters for the particular area to be irrigated. Soil texture and structure, hydraulic conductivity of the soil, rooting depth, land slope, etc. are evaluated and used to generate desired emitter patterns, flow rates, irrigation runtimes, etc.

To modularize the system design, and allow generic kits to be sold for unknown ground areas, pipes in standardized sizes can be pre-drilled in a relatively close together and regular pattern of emitter ports. Although more ports may be available in such modular, pre-drilled pipes, than desired for optimal surface flow irrigation, the unused ports can be closed by application of sealing plugs (e.g., solid plastic or rubber barbs that seal off the ports). The same design as the sealing adapters 16 discussed above may also be employed (e.g., the annular sleeve design illustrated in FIGS. 3A-B, except that in place of the coupling nozzles, solid sealing barbs may be used).

In another variation to the modular kit embodiment, the sealing plugs may be designed to apply to the openings 24 of emitter tubes (instead of the emitter ports in the pipes), in which case, emitter assemblies are placed in all pre-drilled emitter ports, but those which are not needed for irrigation can be closed off using the sealing plugs.

By including an assortment of sealing plugs, sealing adapters, emitter tubes, various preset mechanical or regulable pressure compensating flow emitters (with different flow rates between 1-20 gallons per hour), and uniformly pre-drilled pipes, the irrigation pattern can be customized on site by the designer/installer. Thus, kits can be provided in accordance with an embodiment of the present invention. Such kits also may comprise one or more pressure regulators, water filters, air relief valves, and drains. Accordingly, difficult to irrigate areas (e.g., with porous soil, high slope angles, etc.), can be provided with more emitters and/or higher flow rate emitters per area compared to low-lying, moisture prone areas, where sealing plugs can block the emitter ports in the underlying pipes (or the emitter openings) to prevent over-irrigation in such areas. The kits may optionally also include instructions for irrigation grid design and assembly, one or more controllers, and one or more fertilizer, pesticide, or insecticide injectors.

The surface flow emitter tube is illustrated as a round tube extending from the sealing adapter at the PVC pipe to a location just above the ground surface. Of course other tube geometries are encompassed by the present disclosure. In particular, the emitter tube may comprise sections of ¼ inch round flexi pipe of different lengths based upon the depth of the PVC pipe. Other diameters may be used in accordance with the present invention.

The pressure compensating flow emitter is preferably selectable or adjustable to allow from about 1 to 20 gallons per hour of fluid to flow through the surface flow emitter tube. More preferably, the emitter flow rate is from about 1 to about 12 gallons per hour. In one embodiment, the flow emitter has a mechanical design that is well known to those of skill in the art, wherein different mechanical pressure compensating flow emitters are selected to yield desired flow rates; these rates can be changed by changing the flow emitter. In another embodiment, the flow allowed through the flow emitter may be regulated in the same emitter by electrical means, or electronic circuitry to facilitate remote adjustment.

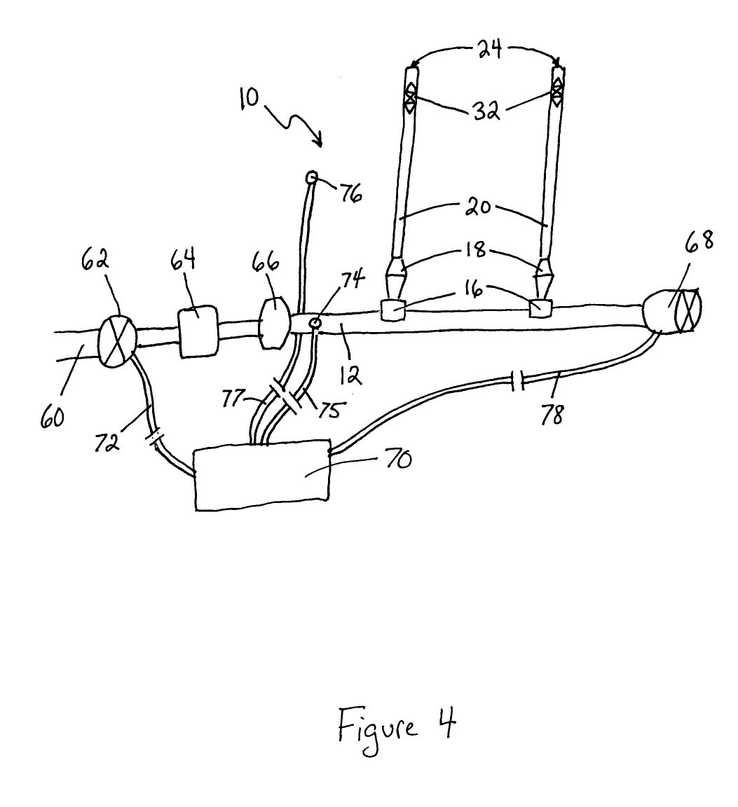

With reference to FIG. 4, a system 10 is shown in accordance with a preferred embodiment of the present invention. The system 10 comprises a source of pressurized fluid 60 and a valve 62, which can be opened and closed to allow irrigation fluid to enter the system. Between the valve 62 and the irrigation pipe 12 are interposed a pressure regulator 64, adapted to maintain a substantially constant fluid pressure within the system when the valve is open. The plumbing is also fitted with a filter 66 adapted to remove undesirable particulate matter from the irrigation fluid. Both the pressure regulator and filter are optional and may not be included in a basic system. The pipe 12 is shown having two emitter assemblies coupled to emitter ports (not shown) via sealing adapters 16. The adapters are coupled directly to pressure compensating flow emitters 18 which are coupled to emitter tubes 20. Within the emitter tubes, between the pressure compensating flow emitters and the distal opening (emission orifice) are disposed turbulence regulators 32, adapted to maintain a backpressure to minimize undesired emission turbulence. An air relief valve 68 is fluidly coupled to the pipe 12 and preferably positioned at the highest elevation (relative to the source pipe 60, such that the system can be filled with fluid and the air is displaced upward, through the air relief valve 68. In some embodiments, the system may also be fitted with a drain (not shown), preferably located at the lowest elevation, such that the irrigation fluid can be drained from the system.

The illustrated system is also shown with a controller 70. The controller 70 is shown in operable communication 72 and 78, respectively, with the valve 62 and the air relief valve 68. The controller is also shown receiving input 75 from a pressure sensor 74 disposed within the system, and further input 77 from a soil moisture sensor 76. In some embodiments, the controller may be similar to conventional irrigation system controllers, which can be programmed to open and close the valve 62 in accordance with the irrigation parameters (runtimes). In other embodiments, the controller may be programmed to accept data input from system sensors (e.g., the pressure 74 and moisture 76 sensors in the illustrated embodiment), and make automatic adjustments to the irrigation runtime based on the data input.

In another preferred embodiment (not shown), the controller 70 may be in two-way communication with a remote transceiver, preferably through a wireless communication connection (e.g., radio or cellular communication). In preferred variations to the system, a controller and remote transmitter/receiver (transceiver) is included to allow the irrigation parameters to vary depending on user input and/or automatically depending on transmitted and/or hard-wired weather data received from radio, television, cable suppliers, or any other sources of such information.

A controller may also be used in this system to control the amount of flow through the irrigation system. The controller is particularly useful in preferred embodiments, because the irrigation pattern is different than that of a traditional irrigation system. The controller may also be responsive to environmental changes as discussed above. For example, the controller may be responsive to weather information that it may detect through sensors or which it receives from a remote location. Thus, the irrigation system may, for example, reduce irrigation flow acutely, e.g., during a rain storm, or chronically, e.g., during the rainy season.

The irrigation system may also include a pressure regulator as is well know to those of skill in the art, an air relief valve, and a water filter and injector for fertilizers and chemicals. A means for flushing the system may also be included, which flushing means are well known to those skilled in the art and include for example a drainage valve and an air relief valve.

In one method of using the above system, the flow of fluid next to hardscape areas may be reduced, and the emitters may be more tightly spaced in these areas. In this way, runoff may be reduced if not totally eliminated.

Prior to use, this system is also filled from the lowest point in the irrigation system in a preferred embodiment. Thus, captured air will be eliminated. As discussed above, the irrigation system may also include the use a bug cap, or turbulence regulator placed on top of (or within) the emitter tube to create back pressure to eliminate air bubbles and provide even surface flow. In some embodiments, the irrigation system may have a manual air relief and drainage valves rather than automatic valves to ensure the elimination of air in the system.

### REFERENCES

1. Hung, Joe Y. T. (1996), Microirrigation for Landscapes (Principles, Design and Management). P 44-48, 58 by ASK Printing, Pomona, Calif.
2. Hung, Joe Y. T. (1996). Total drip irrigation design and scheduling program. California State polytechnic University Pomona, Calif. Unpublished document.
3. Hung, Joe Y. T. (1996). Sprinkler mixed with shrubs drip irrigation scheduling program. California State Polytechnic University Pomona, Calif. Unpublished document.
4. Hung, Joe Y. T. (1996). Landscape Sprinkler Irrigation (Principles, Design and Management). By ASK Printing, Pomona, Calif.
5. Schartzmass M., and B. Zur. (1985). Emitter Spacing and Geometry of Wetted Soil Volume. Journal of Irrigation and Drainage Engineering ASCE 112 (3): 243-253.
6. Hung, Joe and Dave Koo (1993). Determination of Emitter Spacing and Run Time for Maximum Water Use Efficiency, Paper presented at the Irrigation Association's 1993 International Exposition and Technical Conference.
7. Hung Joe Y. T. and Alan C. Krinik (1995): The 5^{th} International Microirrigation Congress Conference, Apr. 2-6, 1995.
8. Israelsen, Olson W. et al (1962). Irrigation Principles and Practices. P 273.

While a number of preferred embodiments of the invention and variations thereof have been described in detail, other modifications and methods of making and using the disclosed surface irrigation systems and methods will be apparent to those of skill in the art. Accordingly, it should be understood that various applications, modifications, and substitutions may be made of equivalents without departing from the spirit of the invention or the scope of the claims. Further, it should be understood that the invention is not limited to the embodiments set forth herein for purposes of exemplification, but is to be defined only by a fair reading of the appended claims, including the full range of equivalency to which each element thereof is entitled.

All of the references cited herein are incorporated in their entirety by reference thereto.

1. An irrigation system for irrigating a ground surface, comprising:
at least one pipe located beneath the ground surface and coupled to a pressurized fluid source, wherein the at least one pipe further comprises at least one emitter port; and
at least one emitter assembly coupled to the at least one emitter port and configured to deliver the pressurized fluid from the at least one pipe to the ground surface at a substantially constant flow rate, wherein the at least one emitter assembly comprises:
a sealing adapter configured to couple the emitter assembly to the at least one emitter port;
an emitter tube having an elongate tubular body sized to convey the pressurized fluid to a location along the ground surface;
a pressure compensating flow emitter configured to permit the pressurized fluid to flow through the emitter assembly to the location at a substantially constant flow rate when the fluid pressure in the at least one pipe is within a permissive pressure range.

2. The irrigation system of claim 1, wherein the permissive pressure range is about 10 to 35 psi.

3. The irrigation system of claim 1, further comprising a valve between the pressurized fluid source and the at least one pipe, and a pressure regulator between the valve and the at least one pipe, wherein the pressure regulator is adapted to maintain the fluid pressure in the at least one pipe within the permissive pressure range when the valve is open.

4. The irrigation system of claim 3, further comprising at least one controller adapted to open and close the valve in accordance with a programmed irrigation schedule.

5. The irrigation system of claim 4, further comprising a sensor adapted to monitor a selected irrigation value and communicate said irrigation value to the at least one controller, wherein the controller is further programmed to open or close the valve in response to said irrigation value.

6. The irrigation system of claim 4, wherein the at least one controller is further configured for two-way communication with a remote transceiver, such that data transmitted from the remote transceiver can modify the programmed irrigation schedule.

7. The irrigation system of claim 6, wherein the data transmitted from the remote transceiver relates to weather conditions.

8. The irrigation system of claim 1, wherein the emitter tube further comprises a turbulence regulator that interferes with a flow of pressurized fluid through the emitter tube to the location, thereby creating a backpressure in the emitter tube, such that a controlled emission of pressurized fluid is maintained at the location.

9. The irrigation system of claim 1, wherein the at least one pipe further comprises a series of pipes interconnected to form a grid beneath the ground surface.

10. The irrigation system of claim 1, wherein the at least one pipe has a plurality of emitter ports distributed in a predetermined pattern based on an irrigation profile of the ground surface to be irrigated.

11. The irrigation system of claim 10, wherein the plurality of emitter ports are evenly or unevenly distributed along the at least one pipe.

12. The irrigation system of claim 10, wherein the plurality of emitter ports are spaced from about 3 inches to about 36 inches from one another.

13. The irrigation system of claim 1, further comprising at least one sealing plug configured to close a selected emitter port or emitter assembly, such that only some of the emitter ports or emitter assemblies are open for irrigating the ground surface.

14. The irrigation system of claim 1, wherein the at least one pipe comprises a 5, 10 or 20 foot length.

15. The irrigation system of claim 1, wherein the pressure compensating flow emitter is selected from a variety of different pressure compensating flow emitters each of which is preset to permit a substantially constant flow rate of between 1 and 20 gallons per hour, wherein the selection is based at least in part on a calculated irrigation parameter.

16. The irrigation system of claim 15, wherein the irrigation parameter is determined by a computer program based on input irrigation profile values.

17. The irrigation system of claim 16, wherein one or more of the input irrigation profile values are selected from the group consisting of soil type, plant type, ground slope, evapotranspiration rate, and weather.

18. An irrigation system for irrigating a ground surface, comprising:
a series of interconnected PVC pipes arranged to form a grid beneath the ground surface, wherein the PVC pipes are in fluid communication with one another and coupled to a pressurized fluid source comprising a valve and a pressure regulator, which is adapted to maintain the fluid pressure within the permissive pressure range when the valve is open, and wherein one or more of the PVC pipes has a plurality of emitter ports;
a plurality of emitter assemblies configured to deliver the pressurized fluid from the PVC pipes to the ground surface when the valve is open, wherein each emitter assembly comprises:
a sealing adapter configured to couple the emitter assembly to an emitter port;
an emitter tube having an elongate tubular body sized to convey the pressurized fluid to a location along the ground surface;
a pressure compensating flow emitter configured to permit the pressurized fluid to flow through the emitter assembly to the location at a selected flow rate when the fluid pressure is within the permissive pressure range; and
a turbulence regulator that interferes with the flow of the pressurized fluid through the emitter tube to the location, thereby creating a backpressure in the emitter tube, such that a controlled emission of pressurized fluid is maintained at the location;
a plurality of sealing plugs configured to close selected emitter ports or emitter assemblies, such that only some of the plurality of emitter assemblies are used for irrigating the ground surface; and
a controller adapted to open and close the valve in accordance with an irrigation schedule.

19. A surface irrigation kit, comprising:
a plurality of PVC pipes, each comprising a plurality of pre-drilled emitter ports;
a plurality of sealing adapters;
a plurality of emitter tubes;
an assortment of different pressure compensating flow emitters, each configured permit a selected constant flow rate; and
a plurality of sealing plugs.

20. The surface irrigation kit of claim 19, further comprising a controller.

21. An irrigation method for irrigating a ground surface, comprising:
determining a surface irrigation design, comprising emitter assembly spacing based on selected properties of the ground surface;
determining surface irrigation parameters, comprising an emitter flow rate and a runtime, based on selected properties of the ground surface;
constructing an irrigation system, comprising:
a source of pressurized irrigation fluid having a valve;
an irrigation pipe in fluid communication with the source of pressurized irrigation fluid, and comprising an emitter port;
an emitter assembly coupled to the emitter port via a sealing adapter and comprising an emitter tube with a turbulence regulator and a pressure compensating flow emitter selected to provide the determined emitter flow rate;
opening the valve; and
closing the valve after the determined runtime.
